(19) United States
(12) Patent Application Publication
(10) Pub. No.: US 2009/0269543 A1
(43) Pub. Date: Oct. 29, 2009

(54) OPTICAL RECORDING MEDIUM

(75) Inventors: Atsushi Monden, Tokyo (JP); Masahiro Shinkai, Tokyo (JP); Motohiro Inoue, Tokyo (JP)

Correspondence Address: OLIFF & BERRIDGE, PLC, P.O. BOX 320850, ALEXANDRIA, VA, 22320-4850, US

(73) Assignee: TDK CORPORATION, Tokyo (JP)

(21) Appl. No.: 12/065,175

(22) PCT Filed: Sep. 25, 2006
(86) PCT No.: PCT/JP2006/318975

§ 371 Date: Feb. 28, 2008

(30) Foreign Application Priority Data
Sep. 27, 2005 (JP) 2005-280664

(51) Int. Cl. B32B 3/02

(52) U.S. Cl. 428/64.8; 428/64.4

(57) ABSTRACT

An optical recording medium comprises a laminate of at least two recording layers; each of the recording layers contains a metal complex dye and an organic dye in a predetermined concentration; when the recording layers comprise a first recording layer and a second recording layer in order from a light entrance side, the first recording layer contains 20 to 50 parts by weight of the metal complex dye where a total amount of the metal complex dye and the organic dye is 100 parts by weight, and the second recording layer contains 20 to 100 parts by weight of the metal complex dye where a total amount of the metal complex dye and the organic dye is 100 parts by weight. The optical recording medium is provided as one with a satisfactorily excellent initial error rate and a satisfactorily excellent error rate after a light resistance test, in each of the recording layers.

### TECHNICAL FIELD

The present invention relates to an optical recording medium permitting recording of information and readout of information by irradiation with light.

### BACKGROUND ART

The optical recording media with recording layers containing a dye, e.g., CD-R and DVD-R, permit recording of large volume of information and random access. Therefore, they are widely recognized and used as external recording devices in information processing apparatus like computers.

Recently, increase in volume of information to be handled has raised demands for further increase in recording capacity of the optical recording media. For this reason, there are proposals on the so-called single-sided two-layer optical recording media in which there are two recording layers containing a dye, on a substrate and which permit recording of information into the two recording layers from one side and readout of the information recorded in the two recording layers, from one side (e.g., cf. Patent Documents 1-4).

In the present specification, the recording layers will be referred to as a first recording layer and a second recording layer in order from the light entrance side.

### Patent Document 1: Japanese Patent Application Laid-open No. 2003-331463

### Patent Document 2: Japanese Patent Application Laid-open No. 2003-331473

### Patent Document 3: Japanese Patent Application Laid-open No. 2003-178490

### Patent Document 4: Japanese Patent Application Laid-open No. 2003-170664

### DISCLOSURE OF THE INVENTION

### Problem to be Solved by the Invention

The single-sided two-layer optical recording media of this type are required to have sufficiently low initial error rates immediately after recording in the respective recording layers and sufficiently low error rates after recording and after a light resistance test.

In such single-sided two-layer optical recording media, however, since light having passed through the first recording layer is used for recording in the second recording layer and readout of information from the second recording layer, the characteristics of the first recording layer also affect the characteristics of the second recording layer. It was, therefore, difficult to achieve the initial error rates and the error rates after the light resistance test at adequate levels in both of the first recording layer and the second recording layer.

The present invention has been accomplished in view of the above circumstances and an object of the invention is to provide an optical recording medium with sufficiently excellent initial error rates and error rates after the light resistance test for the respective recording layers.

### Means for Solving the Problem

The inventors conducted elaborate research to achieve the above object and discovered that the optical recording media with the sufficiently excellent initial error rates and error rates after the light resistance test in the respective recording layers were realized by defining each of a compounding ratio of a metal complex dye and an organic dye in a first recording layer and a compounding ratio of a metal complex dye and an organic dye in a second recording layer in a predetermined range, thereby accomplishing the present invention.

An optical recording medium according to the present invention comprises a laminate of at least two recording layers, wherein each of the recording layers contains a metal complex dye and an organic dye in a predetermined concentration, wherein, when the recording layers comprise a first recording layer and a second recording layer in order from a light entrance side, the first recording layer contains 20 to 50 parts by weight of the metal complex dye where a total amount of the metal complex dye and the organic dye is 100 parts by weight, and the second recording layer contains 20 to 100 parts by weight of the metal complex dye where a total amount of the metal complex dye and the organic dye is 100 parts by weight.

This optical recording medium exhibits satisfactorily good values of the initial error rates and the error rates after the light resistance test in the first recording layer and the second recording layer.

In contrast to it, if the first recording layer contains less than 20 parts by weight of the metal complex dye where the total amount of the metal complex dye and the organic dye is 100 parts by weight, it will result in degradation of the error rate after the light resistance test in the first recording layer. On the other hand, if the first recording layer contains more than 50 parts by weight of the metal complex dye where the total amount of the metal complex dye and the organic dye is 100 parts by weight, it will result in increase in the initial error rate in the first recording layer. Furthermore, if the second recording layer contains less than 20 parts by weight of the metal complex dye where the total amount of the metal complex dye and the organic dye is 100 parts by weight, it will result in degradation of the error rate after the light resistance test in the second recording layer.

The reason why such a good optical recording medium is obtained depending upon the concentration conditions of the respective recording layers is not always clear, but a conceivable cause is, for example, as described below. In general, an organic dye has poor light resistance. This is conceivably because it is readily decomposed by singlet oxygen made by light irradiation. On the other hand, a metal complex dye has a function to deactivate singlet oxygen (which will be referred to hereinafter as a quencher effect) and when it is added to the organic dye, the light resistance of the whole dyes can be enhanced. However, when an amount of the metal complex dye added is small, the quencher effect is low, to increase the error rate after the light resistance test. In addition, many metal complex dyes generate a considerable amount of heat during recording (or during thermal decomposition). This heat generation leads to degradation of the initial error rate. Particularly, a semitransparent reflecting layer used for the first recording layer is very thin, ten and several nm, and thermal diffusion is insufficient during recording; therefore, excessive addition of the metal complex dye will result in increase in the amount of generated heat and, in turn, degradation of error rates. It is, therefore, considered that optimization of the compounding ratios is important.

Preferably, the first recording layer contains 35 to 50 parts by weight of the metal complex dye where the total amount of the metal complex dye and the organic dye is 100 parts by weight. In this case, a further reduction is achieved in the error rate after the light resistance test in the first recording layer.

Preferably, the second recording layer contains 60 to 100 parts by weight of the metal complex dye where the total amount of the metal complex dye and the organic dye is 100 parts by weight. In this case, a further reduction is achieved in the error rate after the light resistance test in the second recording layer.

Particularly preferably, the first recording layer contains 35 to 50 parts by weight of the metal complex dye where the total amount of the metal complex dye and the organic dye is 100 parts by weight and the second recording layer contains 60 to 100 parts by weight of the metal complex dye where the total amount of the metal complex dye and the organic dye is 100 parts by weight.

Preferably, the metal complex dye is an azo metal complex dye.

Particularly preferably, the azo metal complex dye is a complex compound of an azo compound represented by General Formula (1) below, and a metal;

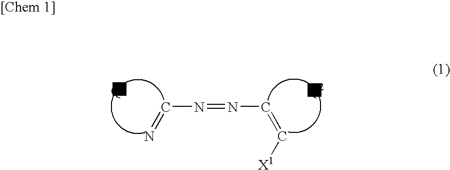

wherein Q¹ indicates a divalent residue binding to each of a nitrogen atom and a carbon atom binding to the nitrogen atom, to form a heterocyclic ring or a fused ring including the heterocyclic ring, Q² a divalent residue binding to each of two carbon atoms binding to each other, to form a fused ring, and X¹ a functional group having at least one active hydrogen atom.

Preferably, the organic dye is a cyanine dye.

Preferably, the cyanine dye has a group represented by General Formula (2) or (3) below;

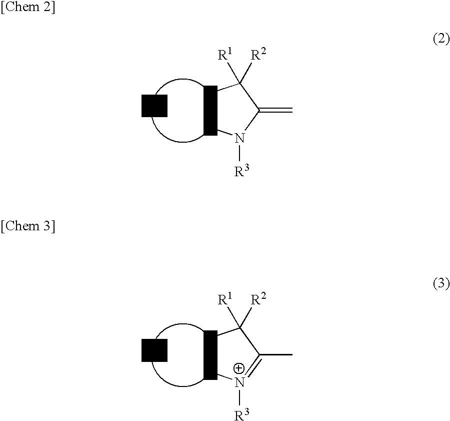

wherein Q³ indicates an atom group constituting a benzene ring that may have a substituent group or a naphthalene ring that may have a substituent group, R¹ and R² each independently indicate an alkyl group, a cycloalkyl group, a phenyl group, or a benzyl group that may have a substituent group, or indicate a group forming a three-, four-, five-, or six-membered ring while they bind to each other, R³ indicates an alkyl group, a cycloalkyl group, an alkoxy group, a phenyl group, or a benzyl group that may have a substituent group, and the foregoing groups indicated by R¹, R², and R³ may have a substituent group.

Preferably, the recording layers comprise only two layers.

A specific configuration of the optical recording medium according to the present invention comprises a substitute; the first recording layer provided on the substrate; a semitransparent reflecting layer provided on the first recording layer; a spacer layer provided on the semitransparent reflecting layer; the second recording layer provided on the spacer layer; and a reflecting layer provided on the second recording layer.

### EFFECT OF THE INVENTION

The present invention succeeded in providing the optical recording medium with sufficiently excellent initial error rates and error rates after the light resistance test in both of the first recording layer and the second recording layer.

### BRIEF DESCRIPTION OF THE DRAWINGS

FIG. 1 is a sectional schematic view of an optical recording medium according to the present invention.

FIG. 2 is a table showing configurations of recording layers and characteristic evaluation results of the respective recording layers as to Examples a1-a15.

FIG. 3 is a table showing configurations of recording layers and characteristic evaluation results of the respective recording layers as to Comparative Examples a1-a27.

FIG. 4 is a table showing configurations of recording layers and characteristic evaluation results of the respective recording layers as to Examples b1-b11 and Comparative Examples b1-b6.

### DESCRIPTION OF REFERENCE SYMBOLS

10 substrate; 20 first recording layer; 30 semitransparent reflecting layer; 40 spacer layer; 50 second recording layer; 60 reflecting layer; 70 adhesive layer; 80 dummy substrate; 12, 42 grooves; 100 optical recording medium

### BEST MODE FOR CARRYING OUT THE INVENTION

The preferred embodiment of the present invention will be described below in detail with reference to the drawings as occasion may demand. It is noted that vertical, horizontal, and other positional relations are based on the positional relations illustrated in the drawings, unless otherwise stated. Furthermore, the dimensional ratios in the drawings are not limited to the illustrated ratios.

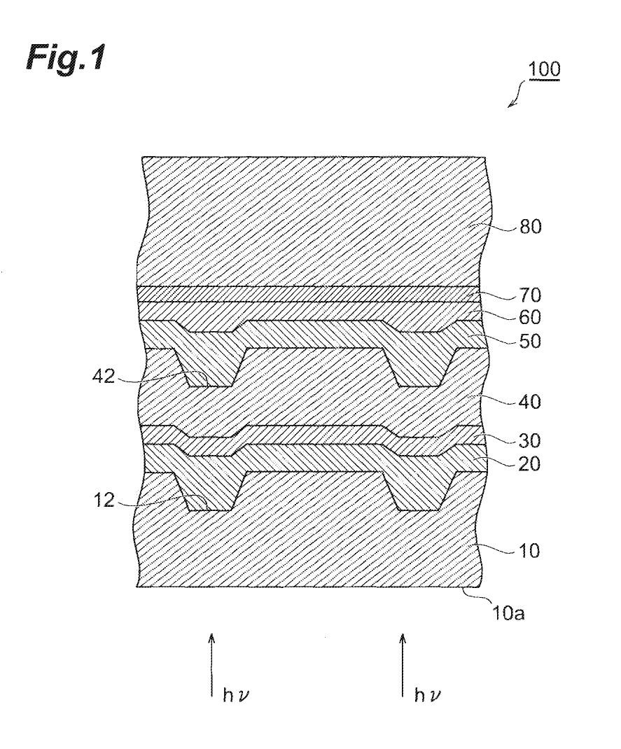

A structure of an optical recording medium according to the present embodiment will be first described with reference to FIG. 1. FIG. 1 is a partial sectional view showing a preferred embodiment of the optical recording medium 100 of the present invention. The optical recording medium 100 shown in FIG. 1 has a multilayer structure in which a first recording layer 20, a semitransparent reflecting layer 30, a spacer layer 40, a second recording layer 50, a reflecting layer 60, an adhesive layer 70, and a dummy substrate 80 are provided in close contact in the order named, on a substrate 10. The optical recording medium 100 is a write-once optical recording disk and permits recording and readout with light of short wavelengths of 630-685 nm. The light for recording and readout is radiated onto the optical recording medium 100 from the substrate 10 side, i.e., from bottom in FIG. 1.

(Substrate 10)

The substrate 10 is of a disk shape, for example, in the diameter of about 64-200 mm and in the thickness of about 0.6 mm. The light incident from the substrate 10 is used to implement recording in the first recording layer 20 and in the second recording layer 50 and readout of data from these recording layers. For this reason, at least the substrate 10 is preferably substantially transparent for the recording light and the readout light and, more specifically, the substrate 10 preferably has the transmittance of not less than 88% for the recording light and the readout light. A material of this substrate 10 is preferably resin or glass that satisfies the above condition for the transmittance and, among others, the material is particularly preferably selected from thermoplastic resins such as polycarbonate resin, acrylic resin, amorphous polyethylene, TPX, and polystyrene-based resin.

A groove 12 for tracking is formed as a recess in a surface of the substrate 10 where the first recording layer 20 is formed, i.e., on the inner side. The groove 12 is preferably a spiral continuous groove and preferred dimensions thereof are as follows: the depth is 0.1-0.25 μm, the width 0.20-0.50 μm, and the groove pitch 0.6-1.0 μm. When the groove is formed in this configuration, a good tracking signal can be obtained without reduction in a reflection level of the groove. The groove 12 can be formed at the same time as the substrate 10 is molded by injection molding or the like from the aforementioned resin, but it is also possible to adopt a complex substrate obtained by forming a resin layer with the groove 12 by the 2P process or the like after fabrication of the substrate 10, and combining the substrate 10 and this resin layer.

(First Recording Layer 20)

The first recording layer 20 is a layer containing a predetermined optical recording material. A configuration of the first recording layer 20 will be described below in detail.

The first recording layer 20 contains a metal complex dye and an organic dye. The first recording layer 20 contains 20 to 50 parts by weight of the metal complex dye where a total amount of the metal complex dye and the organic dye in the first recording layer 20 is 100 parts by weight. Particularly, the first recording layer preferably contains 35 to 50 parts by weight of the metal complex dye where the total amount of the metal complex dye and the organic dye is 100 parts by weight.

(Metal Complex Dye)

First, the metal complex dye will be described. The metal complex dye can be selected from various metal complex dyes such as azo metal complex dyes, indoaniline metal complex dyes, ethylenediamine metal complex dyes, azomethine metal complex dyes, phenyl hydroxyamine metal complex dyes, phenanthroline metal complex dyes, nitrosoaminophenol metal complex dyes, pyridyl-triazine metal complex dyes, acetylacetonato metal complex dyes, metallocene metal complex dyes, and porphyrin metal complex dyes. Among these, the metal complex dye is particularly preferably an azo metal complex dye, i.e., a complex compound of an azo compound and a metal. It is also possible to adopt a mixture of a plurality of metal complex dyes.

There are no particular restrictions on the azo metal complex dye as long as it is a complex compound of an azo compound having a functional group represented by —N═N-(azo group), and a metal. For example, the azo metal complex dye is a complex compound of an azo compound in which aromatic rings bind with two respective nitrogen atoms of the aforementioned azo group, and a metal, and a specific example thereof is a complex compound of an azo compound represented by General Formula (1) below, and a metal.

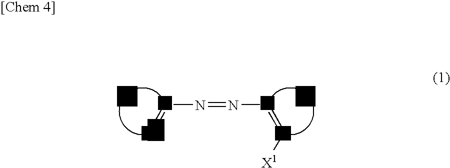

In Formula (1), Q¹ indicates a divalent residue binding to each of a nitrogen atom and a carbon atom binding to the nitrogen atom, to form a heterocyclic ring, or a fused ring including the heterocyclic ring. Q² indicates a divalent residue binding to each of two carbon atoms binding to each other, to form a fused ring.

X¹ is a functional group having at least one active hydrogen and is, for example, a hydroxyl group (—OH), a thiol group (—SH), an amino group (—NH₂), a carboxy group (—COOH), an amide group (—CONH₂), a sulfonamide group (—SO₂NH₂), a sulfo group (—SO₃H), —NSO₂CF₃, or the like.

Such azo compounds include, for example, compounds represented by General Formulae (4) to (7) below.

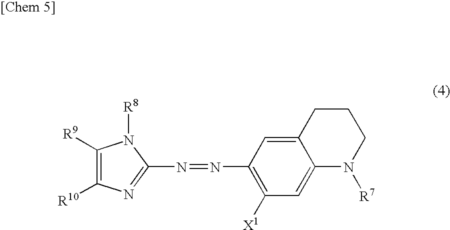

In Formula (4), R⁷ and R⁸ may be the same or different from each other and each independently indicate an alkyl group having one to four carbons; R⁹ and R¹⁰ may be the same or different from each other and each independently indicate a nitrile group or a carboxylic acid ester group; X¹ is the same as the one defined above. The foregoing carboxylic acid ester group is preferably —COOCH₃, —COOC₂H₅, or —COOC₃H₅.

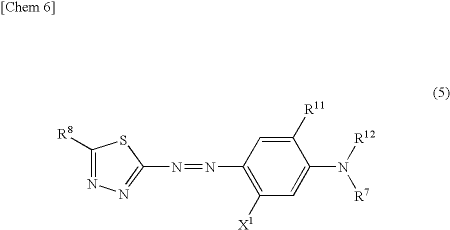

In Formula (5), R¹¹ indicates a hydrogen atom or an alkoxy group having one to three carbons; R¹², R⁷, and R⁸ may be the same or different from each other and each independently indicate an alkyl group having one to four carbons; X¹ is the same as the one described above.

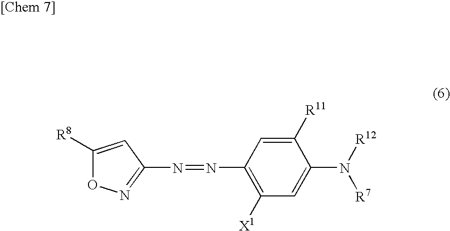

In Formula (6) R¹¹, R¹², R⁷, R⁸ and X¹ are the same as R¹¹, R¹², R⁷, R⁸, and X¹, respectively, in Formula (5).

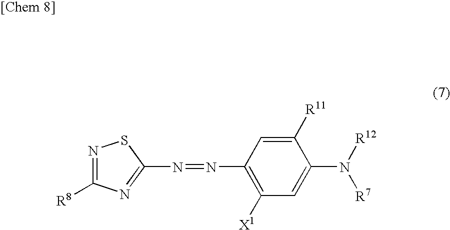

In Formula (7) R¹¹, R¹², R⁷, R⁸, and X¹ are the same as R¹¹, R¹², R⁷, R⁸, and X¹, respectively, in Formula (5).

The metal (central metal) forming the foregoing complex compound is one selected from titanium (Ti), vanadium (V), chromium (Cr), manganese (Mn), iron (Fe), cobalt (Co), nickel (Ni), copper (Cu), zirconium (Zr), niobium (Nb), molybdenum (Mo), ruthenium (Ru), rhodium (Rh), palladium (Pd), silver (Ag), cadmium (Cd), indium (In), tin (Sn), antimony (Sb), tungsten (W), rhenium (Re), osmium (Os), iridium (Ir), platinum (Pt), gold (Au), and so on. As other examples of the metal, V, Mo, and W may also be used in the form of their oxide ions, e.g., VO²⁺, VO³⁺, MoO²⁺, MoO³⁺, WO³⁺, and so on.

The complex compounds of the azo compound of General Formula (1) and the metal include, for example, complex compounds represented by General Formulae (8), (9), and (10) below, complex compounds listed in Tables 1 to 6 below (Nos. A1-A49), and so on. These complex compounds are used singly or in combination of two or more. In the complex compounds represented by Nos. A1-A49, two azo compounds coordinate to one element of the central metal. A complex compound containing two types of azo compounds and two types of central metals is one containing them in a molar ratio of 1:1, and a complex compound with the central metal of “V═O” is one in which the azo compounds coordinate to acetylacetone vanadium.

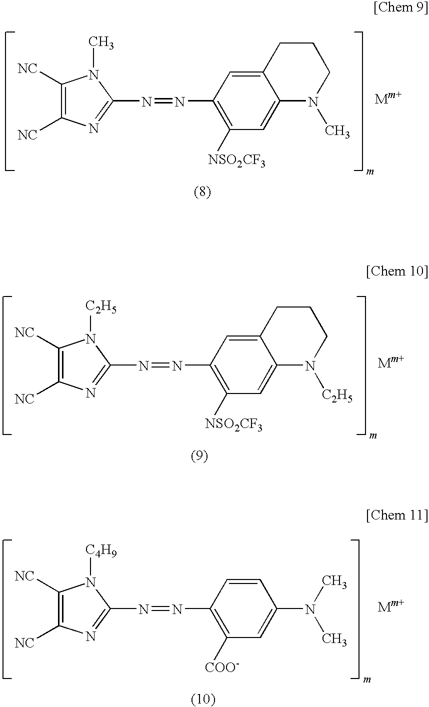

In General Formulae (8), (9), and (10), M indicates Ni²⁺, Co²⁺,

TABLE 1

| No. | [symbol] | [symbol] |
|---|---|---|
| A1 | 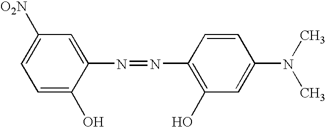 | Co |
| A2 | 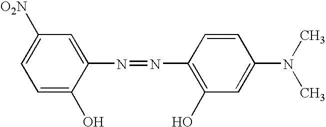 | V═O |
| A3 | 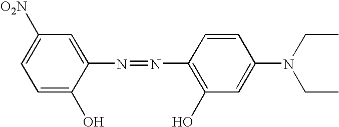 | Co |
| A4 | 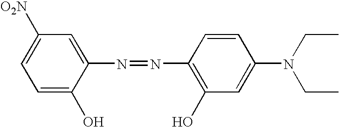 | V═O |
| A5 | 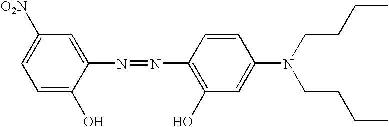 | Co |
| A6 | 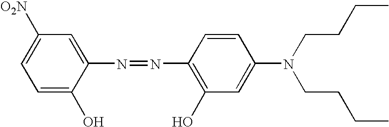 | V═O |
| A7 | 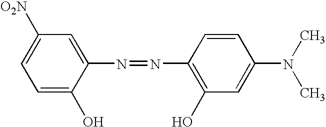 + 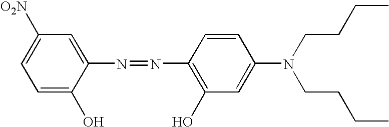 | Co |
| A8 | 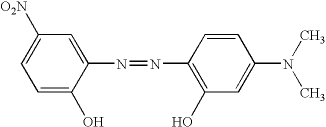 + 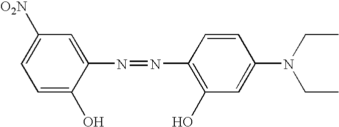 | Co |

TABLE 2

| No. | [symbol] | [symbol] |
|---|---|---|
| A9 | 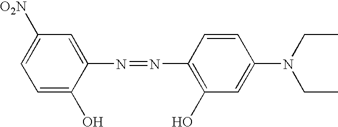 + 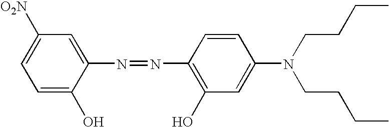 | Co |
| A10 | 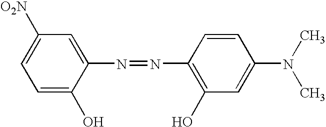 | Co + V═O |
| A11 | 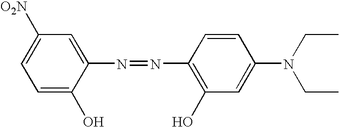 | Co + V═O |
| A12 | 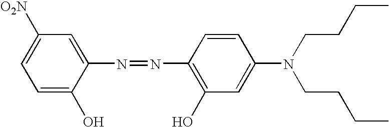 | Co + V═O |
| A13 | 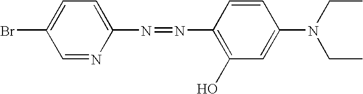 | Cu |
| A14 | 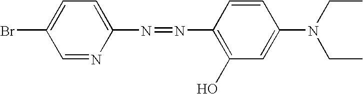 | Ni |
| A15 | 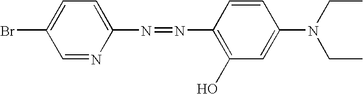 | Co |
| A16 | 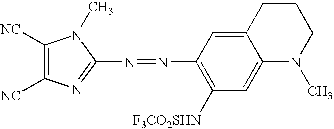 | Ni |
| A17 | 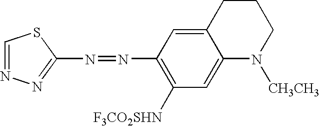 | Ni |

TABLE 3

| No. | [symbol] | [symbol] |
|---|---|---|
| A18 | 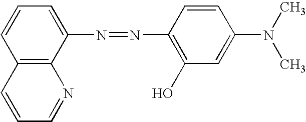 | Co |
| A19 | 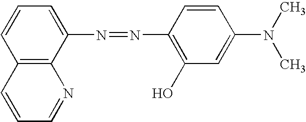 | Ni |
| A20 | 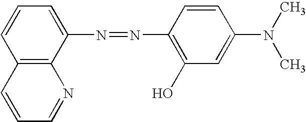 | Cu |
| A21 | 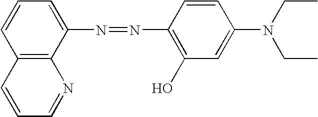 | Co |
| A22 | 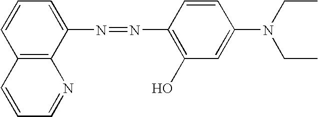 | Ni |
| A23 | 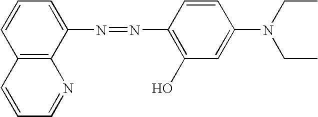 | Cu |
| A24 | 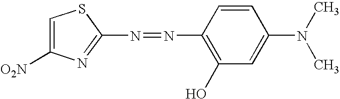 | Cu |
| A25 | 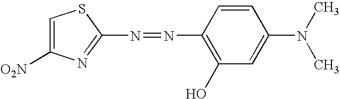 | Ni |
| A26 | 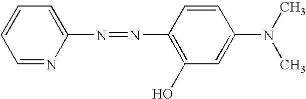 | Cu |
| A27 | 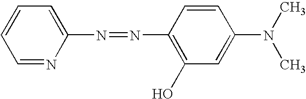 | Ni |

TABLE 4

| No. | [symbol] | [symbol] |
|---|---|---|
| A28 | 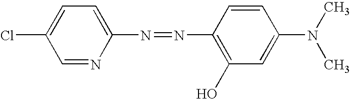 | Cu |
| A29 | 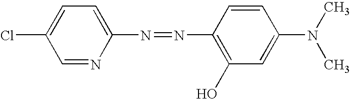 | Ni |
| A30 | 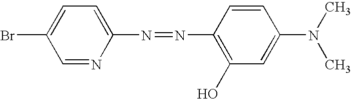 | Cu |
| A31 | 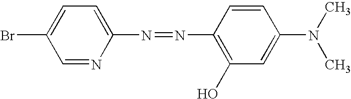 | Ni |
| A32 | 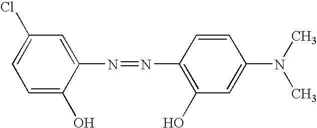 | Co |
| A33 | 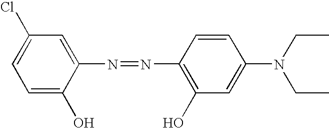 | Co |
| A34 | 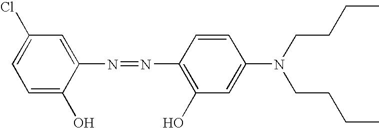 | Co |
| A35 | 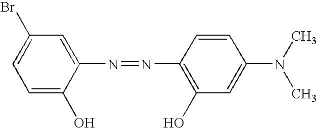 | Co |
| A36 | 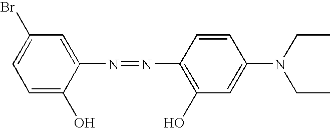 | Co |
| A37 | 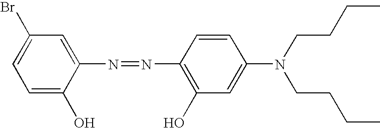 | Co |

TABLE 5

| No. | [symbol] | [symbol] |
|---|---|---|
| A38 | 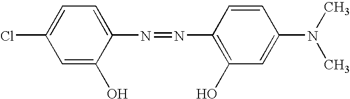 | Co |
| A39 | 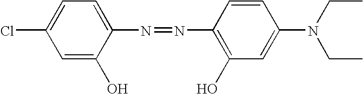 | Co |
| A40 | 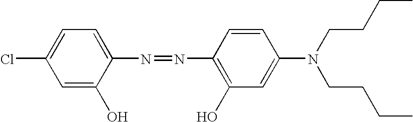 | Co |
| A41 | 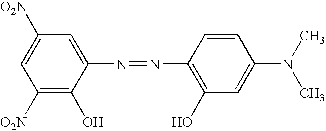 | Co |
| A42 | 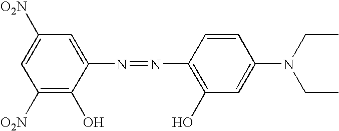 | Co |
| A43 | 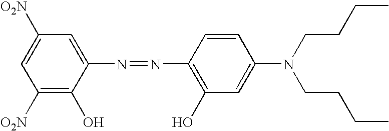 | Co |
| A44 | 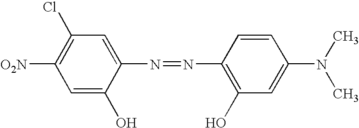 | Co |
| A45 | 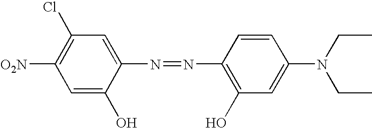 | Co |
| A46 | 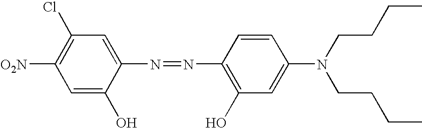 | Co |
| A47 | 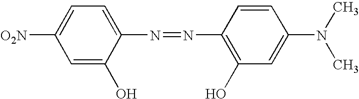 | Co |

TABLE 6

| No. | [symbol] | [symbol] |
|---|---|---|
| A48 | 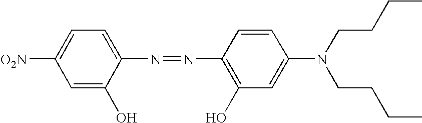 | Co |
| A49 | 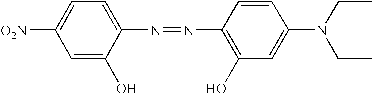 | Co |

The complex compound may also be any one having a structure obtained by excluding the nitro group and diethylamino group from the molecule represented by compound A49.

Depending upon the type of X¹, the complex compound may also be formed in a state in which the active hydrogen of X¹ is dissociated.

The aforementioned complex compound may also be one in the following form: where the complex compound exists as an anion, it may form a salt with a counter cation (counter-cation); or where the complex compound exists as a cation, it may form a salt with a counter anion (counter-anion). In the present specification the weight of the metal complex dye does not include the weight of the counter ion. The counter cations preferably applicable are alkali metal ions such as Na⁺, Li⁺, and K⁺, an ammonium ion, and so on. A cyanine dye described below may also be used as a counter cation to form a salt. Namely, when the organic dye described below is a cation dye or an anion dye, these may be used as a counter ion. Other counter anions preferably applicable include PF₆⁻, I⁻, BF₄⁻, an anion represented by Formula (11) below, and so on.

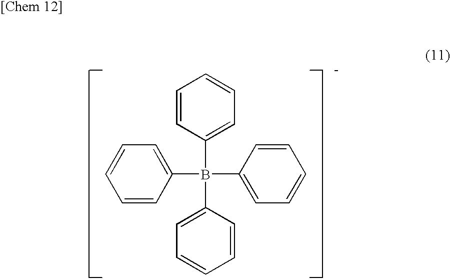

These complex compounds can be synthesized in accordance with well-known methods (e.g., cf. Furukawa, Anal. Chem. Acta., 140, 289 (1982)).

(Organic Dye)

Subsequently, the organic dye will be described. The organic dye may be any organic dye except for the metal complex dyes and may be a well-known one, or one that can be synthesized by well-known methods or in accordance with the well-known methods. Examples of the organic dyes include, for example, cyanine dyes, squarylium dyes, cloconium dyes, azulenium dyes, xanthene dyes, merocyanine dyes, triaryl amine dyes, anthraquinone dyes, azomethine dyes, oxonol dyes, intermolecular CT dyes, and so on.

Among these, the cyanine dyes are preferably applicable and the organic dye is more preferably a cyanine dye having a group represented by General Formula (2) or (3) below.

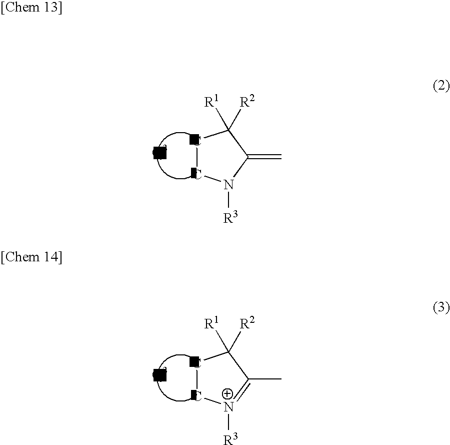

In Formulae (2) and (3), Q³ indicates an atom group constituting a benzene ring that may have a substituent group, or a naphthalene ring that may have a substituent group; R¹ and R² each independently indicate an alkyl group, a cycloalkyl group, a phenyl group, or a benzyl group that may have a substituent group, or a group forming a three-, four-, five-, or six-membered ring while they bind to each other; R³ indicates an alkyl group, a cycloalkyl group, an alkoxy group, a phenyl group, or a benzyl group that may have a substituent group; the groups indicated by R¹, R², and R³ may have a substituent group.

Examples of such cyanine dyes include those represented by General, Formula (12) below, and others.

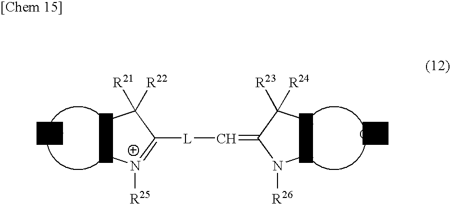

In the formula, L indicates a divalent linking group represented by General Formula (13a) below; R²¹ and R²² each independently indicate an alkyl group having one to four carbons, or a benzyl group that may have a substituent group, or a group forming a three-, four-, five-, or six-membered ring while they bind to each other; R²³ and R²⁴ each independently indicate an alkyl group having one to four carbons or a benzyl group that may have a substituent group, or indicate groups forming a three-, four-, five-, or six-membered ring while they bind to each other; R²⁵ and R²⁶ each independently indicate an alkyl group having one to four carbons, or an aryl group; Q¹¹ and Q¹² each independently indicate an atom group constituting a benzene ring that may have a substituent group, or a naphthalene ring that may have a substituent group. However, at least one of R²¹, R²², R²³, and R²⁴ indicates a group that is not a methyl group, and the divalent linking group represented by General Formula (13a) below may have a substituent group.

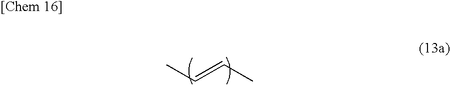

More specific examples of the cyanine dyes include, for example, compounds listed in Tables 7 to 12 below (Nos. T1-T67) and others.

TABLE 7

| No. | |
|---|---|
| T1 | 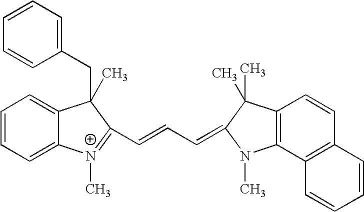 |
| T2 | 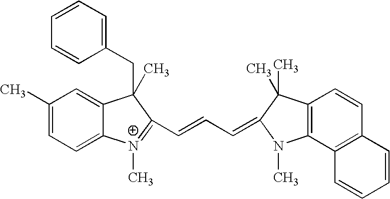 |
| T3 | 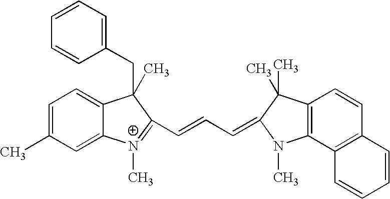 |
| T4 | 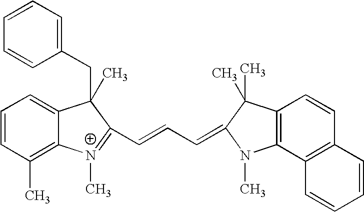 |
| T5 | 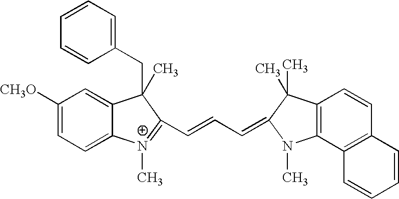 |
| T6 | 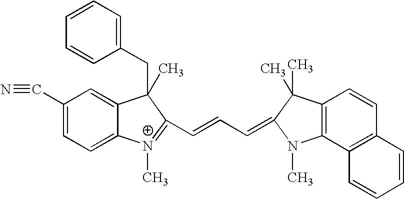 |
| T7 | 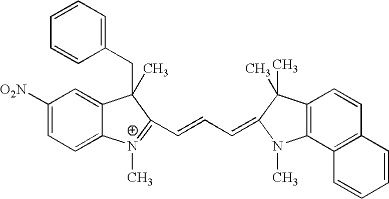 |
| T8 | 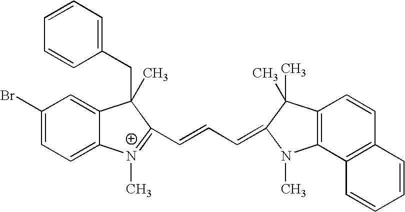 |
| T9 | 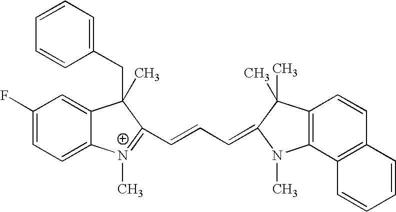 |
| T10 | 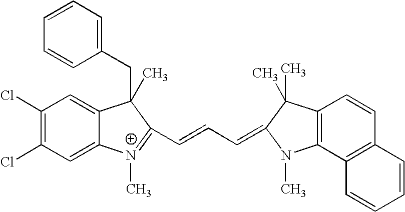 |
| T11 | 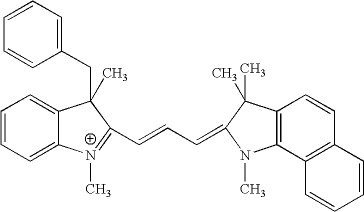 |
| T12 | 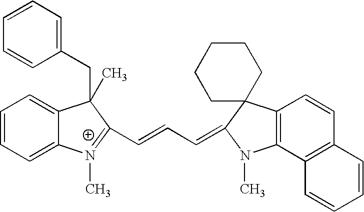 |

TABLE 8

| No. | |
|---|---|
| T13 | 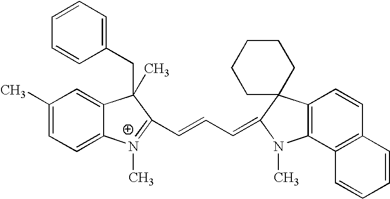 |
| T14 | 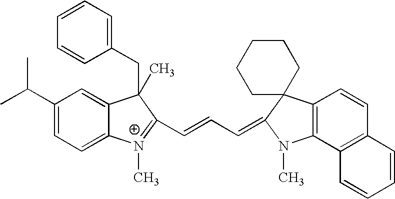 |
| T15 | 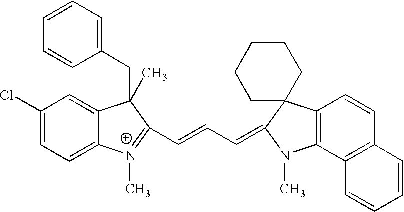 |
| T16 | 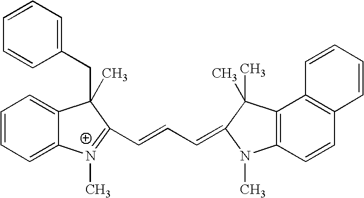 |
| T17 | 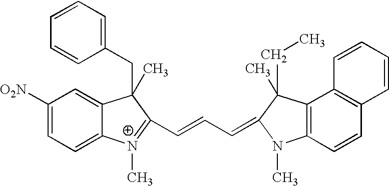 |
| T18 | 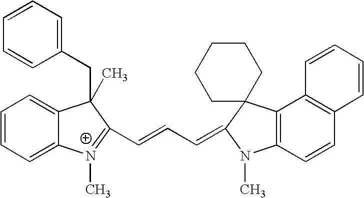 |
| T19 | 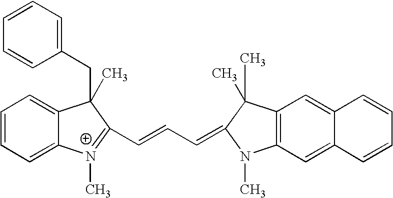 |
| T20 | 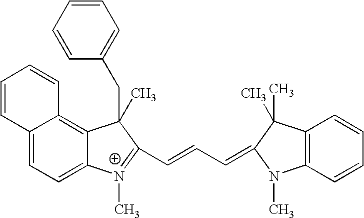 |
| T21 | 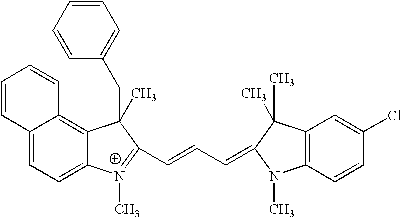 |
| T22 | 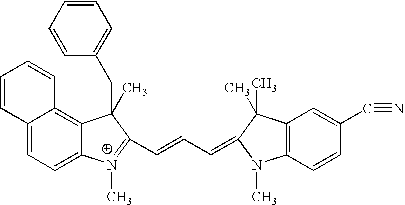 |
| T23 | 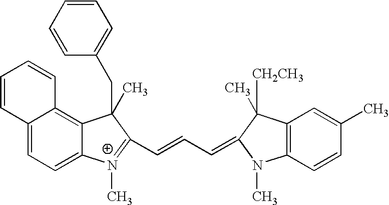 |
| T24 | 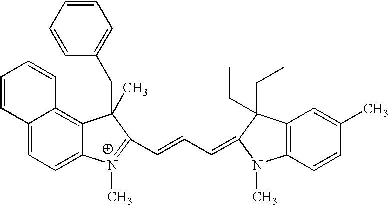 |

TABLE 9

| No. | |
|---|---|
| T25 | 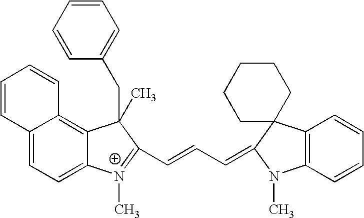 |
| T26 | 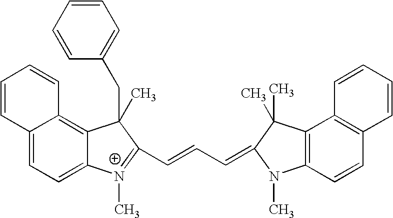 |
| T27 | 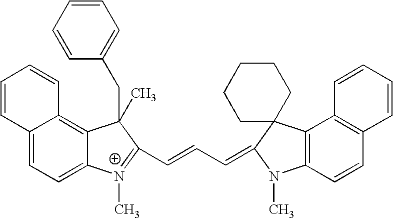 |
| T28 | 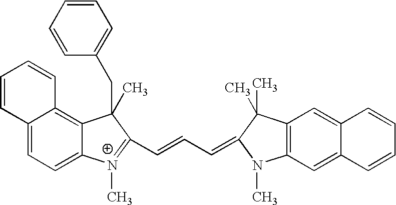 |
| T29 | 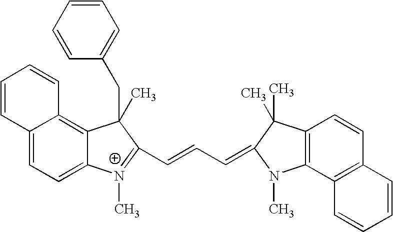 |
| T30 | 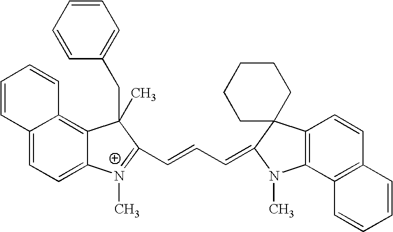 |
| T31 | 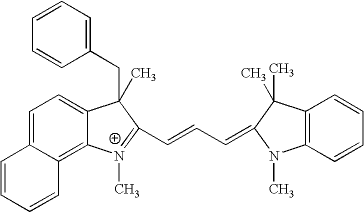 |
| T32 | 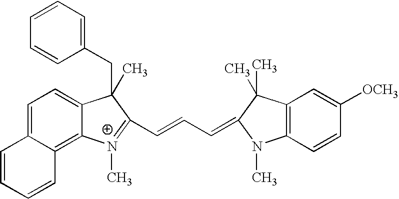 |
| T33 | 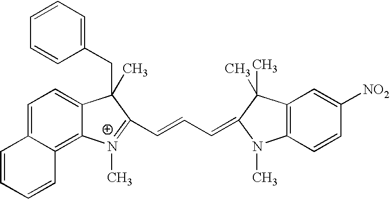 |
| T34 | 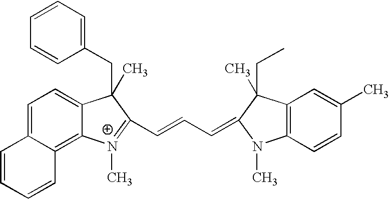 |
| T35 | 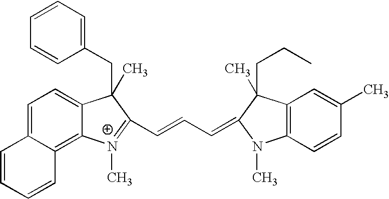 |
| T36 | 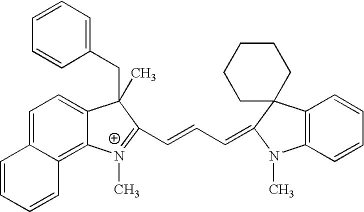 |

TABLE 10

| No. | |
|---|---|
| T37 | 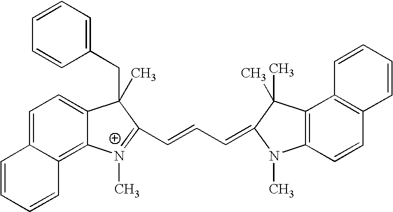 |
| T38 | 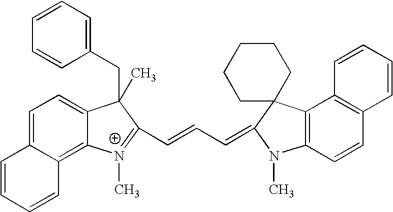 |
| T39 | 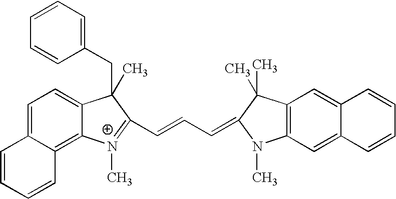 |
| T40 | 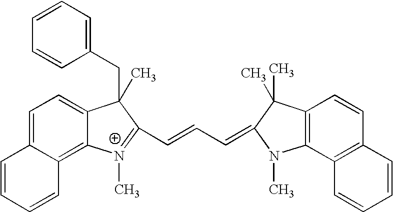 |
| T41 | 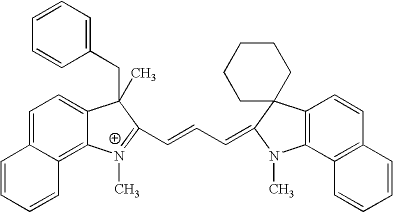 |
| T42 | 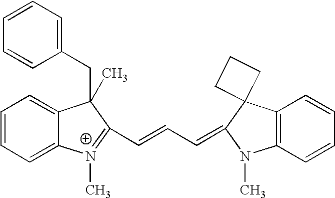 |
| T43 | 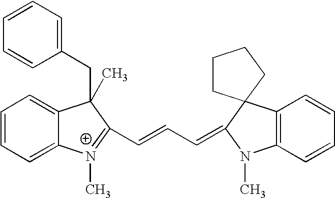 |
| T44 | 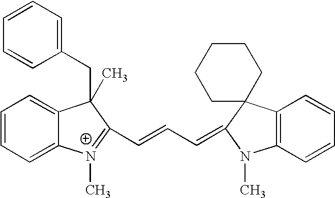 |
| T45 | 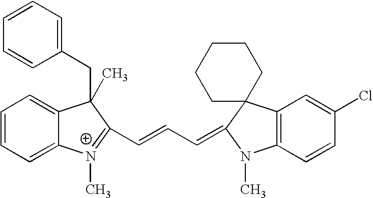 |
| T46 | 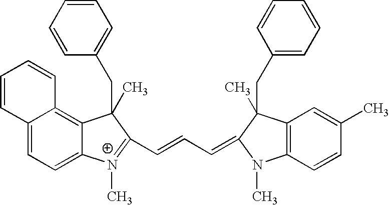 |
| T47 | 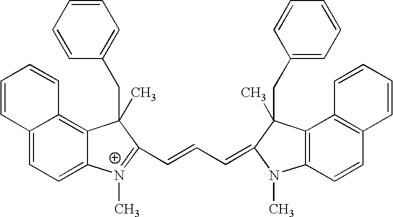 |
| T48 | 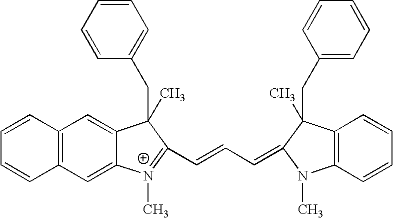 |

TABLE 11

| No. | |
|---|---|
| T49 | 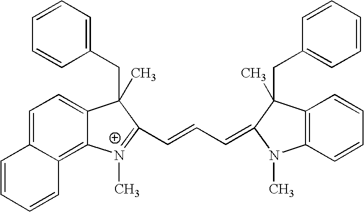 |
| T50 | 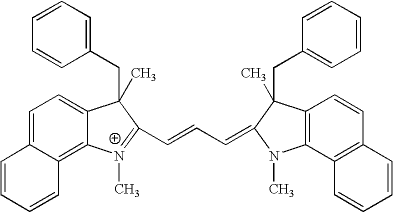 |
| T51 | 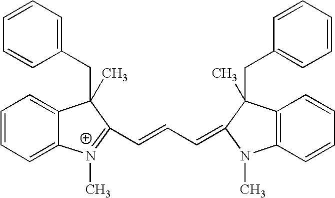 |
| T52 | 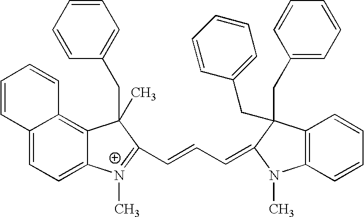 |
| T53 | 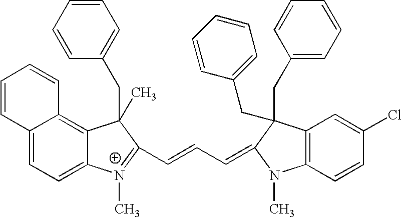 |
| T54 | 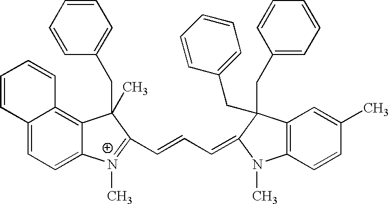 |
| T55 | 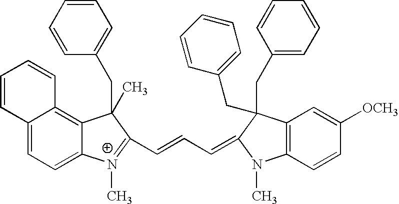 |
| T56 | 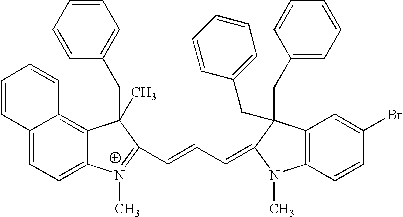 |
| T57 | 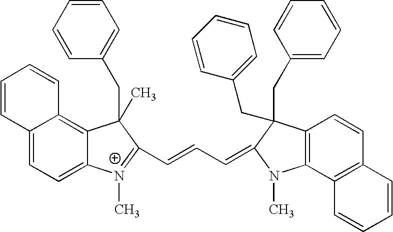 |
| T58 | 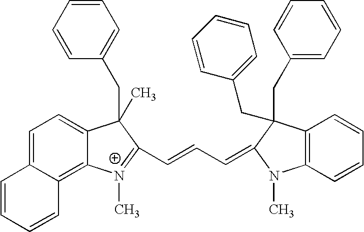 |
| T59 | 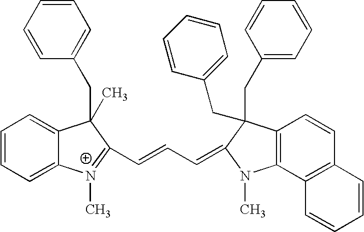 |
| T60 | 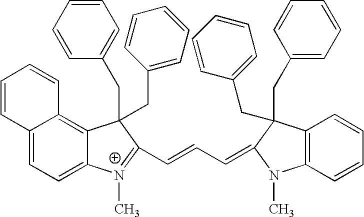 |

TABLE 12

| No. | |
|---|---|
| T61 | 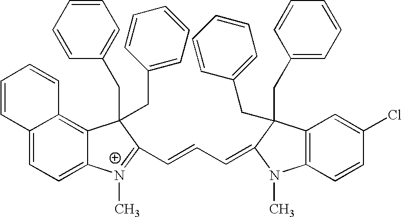 |
| T62 | 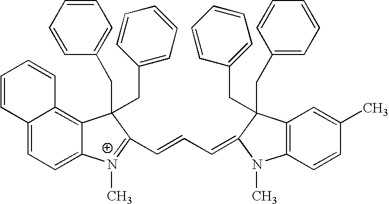 |
| T63 | 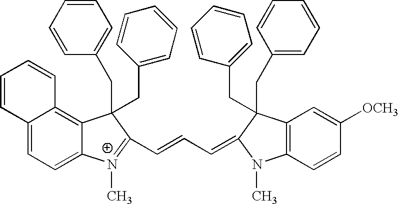 |
| T64 | 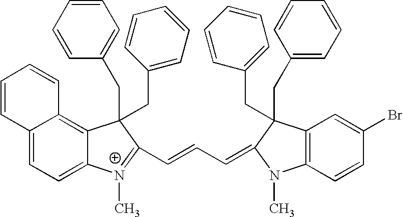 |
| T65 | 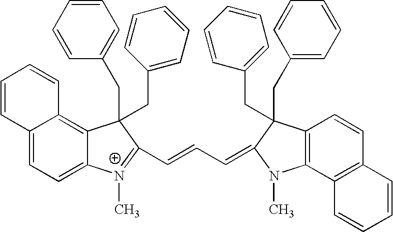 |
| T66 | 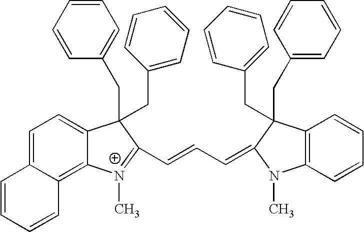 |
| T67 | 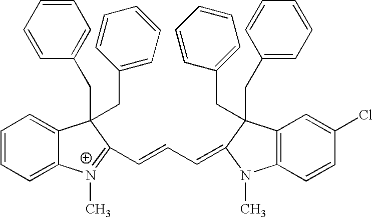 |

The organic dyes are classified in forms of positive ion (cation) dyes like the above-described cyanine dyes (T1-T67), negative ion (anion) dyes, and nonionic (neutral) dyes. Where the organic dye is a positive ion dye, specific examples of the counter anion (counter-anion) include halide ions (Cl⁻, Br⁻, I⁻, etc.), ClO₄⁻, BF₄⁻, PF₆⁻, VO₃⁻, VO₄³⁻, WO₄²⁻, CH₃SO₃⁻, CF₃COO⁻, CH₃COO⁻, HSO₄⁻, CF₃SO₃⁻, para-toluenesulsfonic ion (PTS⁻), p-trifluoromethylphenyl sulfonate ion (PFS⁻), and so on. Among these, preferred counter anions are ClO₄⁻, BF₄⁻, PF₆⁻, SbF₆⁻, and so on. Where the organic dye is a negative ion dye, examples of the counter cation (counter-cation) preferably applicable include alkali metal ions such as Na⁺, Li⁺, and K⁺, an ammonium ion, and so on. The counter ions described in the section of the metal complex dye and the metal complex dye itself are also preferably applicable as the counter ion. In the present specification the weight of the organic dye does not include the weight of the counter ion.

(Production Method of First Recording Layer)

The first recording layer as described above can be formed, for example, by a method of dissolving or dispersing the metal complex dye and the organic dye at the aforementioned concentration ratio in a solvent to obtain a mixture solution, applying this mixture solution onto the substrate 10, and removing the solvent from a coating film. The solvent of the mixture solution can be one selected from alcoholic solvents (including alkoxy alcohol series such as the keto-alcohol series and the ethylene glycol monoalkyl ether series), aliphatic hydrocarbon solvents, ketone solvents, ester solvents, ether solvents, aromatic solvents, halogenated alkyl solvents, and so on and among these, solvents preferably applicable are the alcoholic solvents and the aliphatic hydrocarbon solvents.

The alcoholic solvents preferably applicable are the alkoxy alcohol series, the keto-alcohol series, and so on. The alkoxy alcohol solvents are preferably those with the alkoxy part having one to four carbon atoms and with the alcohol part having one to five carbon atoms, more preferably two to five carbon atoms, and the total number of carbon atoms is preferably 3-7. Specifically, examples of the alkoxy alcohol solvents include ethylene glycol monoalkyl ether (cellosolve) series such as ethylene glycol monomethyl ether (methyl cellosolve), ethylene glycol monoethyl ether (ethyl cellosolve or ethoxy ethanol), butyl cellosolve, and 2-isopropoxy-1-ethanol, 1-methoxy-2-propanol, 1-methoxy-2-butanol, 3-methoxy-1-butanol, 4-methoxy-1-butanol, 1-ethoxy-2-propanol, and so on. Examples of the keto-alcohol series include diacetone alcohol and others. Further examples suitably applicable include fluorinated alcohols such as 2,2,3,3-tetrafluoropropanol.

The aliphatic hydrocarbon solvents preferably applicable include n-hexane, cyclohexane, methyl cyclohexane, ethyl cyclohexane, cyclooctane, dimethyl cyclohexane, n-octane, iso-propyl cyclohexane, t-butyl cyclohexane, and so on and among them, ethyl cyclohexane and dimethyl cyclohexane are preferably applicable.

Examples of the ketone solvents include cyclohexanone and others.

In the present embodiment, particularly preferred solvents are fluorinated alcohols such as 2,2,3,3-tetrafluoropropanol. Other preferred solvents are the alkoxy alcohol series such as the ethylene glycol monoalkyl ether series and among others, solvents preferably applicable are ethylene glycol monoethyl ether, 1-methoxy-2-propanol, 1-methoxy-2-butanol, and so on. The solvents may be used singly or as a mixture of two or more solvents. For example, a solvent mixture of ethylene glycol monoethyl ether and 1-methoxy-2-butanol is suitable applicable.

The mixture solution may also contain a binder, a dispersant, a stabilizer, etc., as needed, in addition to the above-described components.

Methods of applying the mixture solution include spin coating, gravure coating, spray coating, dip coating, etc. and among these the spin coating is preferably applicable.

The thickness of the first recording layer 20 formed in this manner is preferably 50-300 nm. Outside this range, the reflectance is too low to implement reproduction complying with the DVD standard. Furthermore, the modulation degree becomes extremely large when the thickness of the first recording layer 20 located above the groove 12 is not less than 100 nm, particularly, 130 to 300 nm or more.

The extinction coefficient (imaginary part k of the complex refractive index) of the first recording layer 20 for recording light and reproducing light is preferably 0-0.20. If the extinction coefficient exceeds 0.20, the recording layer tends to have insufficient reflectance. The refractive index (real part n of the complex refractive index) of the first recording layer 20 is preferably 1.8 or more. If the refractive index is less than 1.8, the modulation degree of signal tends to become smaller. There are no particular restrictions on the upper limit of the refractive index, but it is normally about 2.6 in terms of convenience for synthesis of the organic dye.

The extinction coefficient and refractive index of the first recording layer 20 can be determined according to the following procedure. First, a sample for measurement is prepared by forming a recording layer in the thickness of about 40-100 nm on a predetermined transparent substrate, and then the reflectance is measured through the substrate of this measurement sample or from the recording layer side. In this ease, the reflectance is measured by specular reflection (about 5°) using the wavelengths of the recording and reproducing light. Furthermore, the transmittance of the sample is measured. Then the extinction coefficient and the refractive index can be calculated from these measured values, for example, in accordance with the method described in Kozo Ishiguro “Optics,” pp 168-178, Kyoiitsu Zensho.

(Semitransparent Reflecting Layer 30)

The semitransparent reflecting layer 30 is a layer that has the optical transmittance of not less than 40% and a moderate optical reflectance. The semitransparent reflecting layer 30 is desirably one having little absorption of light and some corrosion resistance. Furthermore, the semitransparent reflecting layer 30 desirably has a barrier property to prevent the first recording layer 20 from being affected by bleeding of the spacer layer 40.

Specifically, the semitransparent reflecting layer 30 can be, for example, a thin film of a metal or an alloy with a high reflectance.

A material of the semitransparent reflecting layer 30 can be any material with a moderately high reflectance at the wavelength of the reproducing light and can be, for example, any one or an alloy of metals and metalloids such as Au, Al, Ag, Cu, Ti, Cr, Ni, Pt, Ta, Pd, Mg, Se, Hf, V, Nb, Ru, W, Mn, Re, Fe, Co, Rh, Ir, Zn, Cd, Ga, In, Si, Ge, Te, Pb, Po, Sn, Bi, and rare earth metals. Among these, Au, Al, and Ag have high reflectance and are suitable for the material of the semitransparent reflecting layer 30. The material may contain any other component as well as the principal component selected from these.

Among others, preferred materials are alloys containing Ag 50% or more, e.g., Ag—Bi alloy or the like. The concentration of Ag is preferably about 98-99.5 atomic %.

In order to ensure a high transmittance, the thickness of the semitransparent reflecting layer 30 is normally preferably not more than 50 nm. It is more preferably not more than 30 nm. The thickness is still more preferably not less than 20 nm. However, in order to prevent the first recording layer 20 from being affected by the spacer layer 40, some thickness is needed and it is normally not less than 3 nm. The thickness is more preferably not less than 5 nm.

It is also possible to form a multilayer film by alternately stacking low-index thin films and high-index thin films of materials except for metal, and to use the multilayer film as the reflecting layer.

Methods for forming the semitransparent reflecting layer 30 include, for example, sputtering, ion plating, chemical vapor deposition, vacuum evaporation, and so on. A well-known inorganic or organic intermediate layer and/or adhesive layer can be provided between the semitransparent reflecting layer 30 and the first recording layer 20 and/or between the semitransparent reflecting layer 30 and the spacer layer 40 in order to enhance the reflectance, improve recording properties, enhance adhesion, and so on.

(Spacer Layer 40)

The spacer layer 40 is a transparent layer for separating the semitransparent reflecting layer 30 and the second recording layer 50 from each other.

A material of the spacer layer 40 can be, for example, one selected from thermoplastic resins, thermosetting resins, electron radiation curable resins, ultraviolet curable resins (including the delayed curing type), and so on.

The material such as the thermoplastic resin or the thermosetting resin is dissolved in an appropriate solution to prepare a coating solution and it is applied and dried to form the spacer layer. The ultraviolet curable resin is directly used or dissolved in an appropriate solution to prepare a coating solution, and the coating solution is then applied and irradiated with ultraviolet light to be cured, thereby forming the spacer layer. These materials may be used singly or as a mixture of two or more, and may be used as a single layer or as a multilayer film.

Coating methods are such methods as application methods like spin coating and casting, among which the spin coating is preferable. A resin with high viscosity can be applied by screen printing or the like to form the spacer layer. The ultraviolet curable resin is preferably a liquid one at 20-40° C. in terms of productivity because it can be applied without use of a solvent. The viscosity is preferably controlled in the range of 20 to 1000 mPa·s.

Examples of the ultraviolet curable adhesives can be radical ultraviolet curable adhesives and cationic ultraviolet curable adhesives. The radical ultraviolet curable adhesives can be, for example, compositions containing an ultraviolet curable compound and a photopolymerization initiator as essential components. The ultraviolet curable compound can be a monofunctional (meth)acrylate or a polyfunctional (meth)acrylate. These can be used each singly or in combination of two or more.

Since the spacer layer 40 is normally made of resin as described above, it is compatible with the second recording layer 50. Therefore, in order to prevent the second recording layer from being adversely affected, a buffer layer may be provided between the spacer layer 40 and the second recording layer 50. A buffer layer can also be provided between the spacer layer 40 and the semitransparent reflecting layer, in order to prevent damage to the semitransparent reflecting layer 30 as described above.

The thickness of the spacer layer 40 is normally preferably not less than 5 μm. In order to implement focus servo separately for the first recording layer 20 and for the second recording layer 50, some distance is necessary between the two recording layers. The necessary distance is normally 5 μm or more and preferably 10 μm or more though it depends upon a focus servo mechanism.

However, if the spacer layer 40 is too thick the implementation of focus servo to the two layers of recording layers takes a considerable time, and increases a moving distance of an objective lens, and curing takes a long time to pose such problems as reduction of productivity; therefore, the thickness is normally preferably not more than 100 μm.

A groove 42 for the second recording layer 50 is formed on the spacer layer 40 as on the substrate 10. The groove 42 can be made by the 2P process, i.e., by pressing a resin stamper with an indented pattern or the like onto a curable resin such as a photo-curable resin to transfer the pattern, and curing the resin.

(Second Recording Layer 50)

The second recording layer 50 is one made of a predetermined optical recording material. The second recording layer 50 contains a metal complex dye and, if needed, an organic dye. The second recording layer 50 contains 20 to 100 parts by weight of the metal complex dye where the total amount of the metal complex dye and the organic dye in the second recording layer 50 is 100 parts by weight. Particularly, the second recording layer preferably contains 60 to 100 parts by weight of the metal complex dye where the total amount of the metal complex dye and the organic dye is 100 parts by weight.

Examples of the metal complex dye and the organic dye, the production method of the second recording layer 50, etc. are the same as those of the first recording layer 20 and are thus omitted from the description herein.

The metal complex dye in the second recording layer 50 may be the same as or different from the metal complex dye in the first recording layer 20. The organic dye other than the metal complex dye in the second recording layer 50 may be the same as or different from the dye other than the metal complex dye in the first recording layer 20.

(Reflecting Layer 60)

The reflecting layer 60 is a layer that reflects light and can be a thin film of a metal or an alloy with adequate optical reflectance. Examples of the metal and alloy include gold (Au), copper (Cu), aluminum (Al), silver (Ag), AgCu, and so on. The thickness of the reflecting layer 60 is preferably 10-300 nm. This reflecting layer 60 can be readily formed by evaporation, sputtering, or the like.

(Adhesive Layer 70)

The adhesive layer 70 is a layer for bonding the dummy substrate 80 to the reflecting layer 60. The adhesive layer 70 does not always have to be transparent, but it is preferably one with high bond strength and small shrinkage percentage during curing adhesion because the shape stability of the optical recording medium becomes higher.

In order to prevent the reflecting layer 60 from being adversely affected, a well-known inorganic or organic protecting layer can be provided between the adhesive layer 70 and the reflecting layer 60.

The thickness of the adhesive layer 70 is normally preferably not less than 2 μm to achieve sufficient bond strength and sufficient productivity and more preferably not less than 5 μm. However, the thickness is normally preferably not more than 100 μm, for making the optical recording medium as thin as possible and for reducing a curing time to improve productivity.

A material of the adhesive layer 70 can be one selected from hot-melt adhesives, ultraviolet curable adhesives, heat hardening adhesives, sticky adhesives, pressure-sensitive adhesive double coated tapes, etc. and is made by a method suitable for each material, e.g., a roll coater method, a screen printing method, a spin coating method, or the like. In the case of DVD±R, the ultraviolet curable adhesive is used from comprehensive evaluation of workability, productivity, disk properties, etc. and screen printing or spin coating is used.

(Dummy Substrate 80)

The dummy substrate 80 is a substrate similar to the substrate 10. The dummy substrate does not have to be transparent.

The above-described optical recording medium 100 may have any other interposed layer according to need. It may also be provided with any other layer on the outermost surface of the medium.

For implementing recording or writing in the optical recording medium 100 having the above-described configuration, pulsed recording light of a predetermined wavelength is applied to the surface of the substrate 10 of the optical recording medium 100, i.e., to the lower surface of the optical recording medium 100, as shown in FIG. 1. Namely, in this optical recording medium, the outer surface of the substrate 10 is a light entrance surface 10a. At this time, appropriate focusing is implemented to let a desired part in the first recording layer 20 or the second recording layer 50 selectively absorb the energy of the light, so as to change the optical reflectance of the recording layer in that part.

For implementing readout, readout light weaker than the recording light is similarly focused on a desired part in the first recording layer 20 or the second recording layer 50 to measure a difference of reflectance.

Since in the optical recording medium 100 of the present embodiment the proportions of the organic dyes in the first recording layer 20 and in the second recording layer 50 satisfy the respective aforementioned conditions, good values are achieved for the initial error rates and the error rates after the light resistance test in the first recording layer 20 and in the second recording layer 50.

If the first recording layer 20 contains less than 20 parts by weight of the metal complex dye where the total amount of the metal complex dye and the organic dye is 100 parts by weight, the error rate after the light resistance test in the first recording layer 20 will degrade. On the other hand, if the first recording layer 20 contains more than 50 parts by weight of the metal complex dye where the total amount of the metal complex dye and the organic dye is 100 parts by weight, the initial error rate in the first recording layer 20 will increase. Furthermore, if the second recording layer 50 contains less than 20 parts by weight of the metal complex dye where the total amount of the metal complex dye and the organic dye is 100 parts by weight, the error rate after the light resistance test in the second recording layer 50 will degrade.

The above embodiment was described as to the optical recording disk having the two recording layers as recording layers, but the recording layers may be three or more layers. In this case, as long as the above-described conditions are satisfied, good initial error rates and error rates after the light resistance test are demonstrated at least in the first recording layer and the second recording layer.

### EXAMPLES

The present invention will be described below in further detail with examples, but it is noted that the present invention is by no means intended to be limited to these examples.

### Examples a1-a15

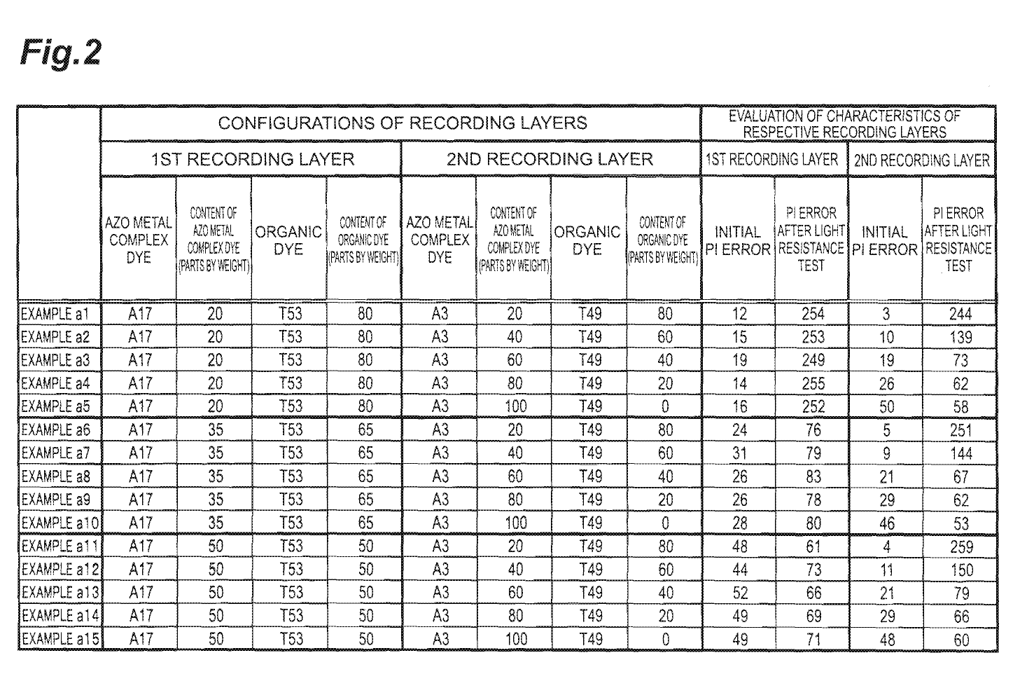

First, a polycarbonate substrate with a spiral pre-groove on one side having the diameter of 120 mm and the thickness of 0.58 mm was prepared. Then a coating solution for the first recording layer was prepared by adding the azo metal complex dye A17 and the cyanine dye T53 to 2,2,3,3-tetrafluoropropanol so that their weight ratio became that in the first recording layer in each of Examples a1-a15 described in FIG. 2 and so that the total concentration of all the dyes became 0.8% by weight. The materials used herein were the neutral azo metal complex dye A16, and a salt of the cyanine dye T53 and PF₆⁻. The coating solution for the first recording layer thus obtained was applied onto the surface where the pre-groove was formed in the polycarbonate resin substrate, by spin coating of 2000 rpm and dried at 80° C. for one hour to form the first recording layer (in the thickness of 110 nm). Then the semitransparent reflecting layer (12 nm thick) was formed on this first recording layer from an Ag—Bi alloy by sputtering.

Subsequently, we prepared a polyolefin stamper having a projection corresponding to the groove of spiral shape in the second recording layer, located the projection of the polyolefin stamper opposite to the semitransparent reflecting layer, placed an ultraviolet curable resin between the stamper and the semitransparent reflecting layer, made the stamper and the substrate rotate at high speed to remove an excess amount of the ultraviolet curable resin, and thereafter applied ultraviolet light through the polyolefin stamper to cure the ultraviolet curable resin. Then the polyolefin stamper was peeled off to form the spacer layer (55 μm thick) with the groove as a tracking groove on the semitransparent reflecting layer.

Next, a coating solution for the second recording layer was prepared by adding the azo metal complex dye A3 and the cyanine dye T49 to 2,2,3,3-tetrafluoropropanol so that their weight ratio became that in the second recording layer in each of Examples a1-a15 described in FIG. 2 and so that the total concentration of all the dyes became 1.0% by weight. The materials used herein were a salt of the azo metal complex dye A3 and tetrabutylammonium ion, and a salt of the cyanine dye T49 and PF₆⁻. The coating solution for the second recording layer thus obtained was applied onto the aforementioned spacer layer by spin coating of 2000 rpm and dried at 80° C. for one hour to form the second recording layer (in the thickness of 130 nm). Then the reflecting layer (120 nm thick) of Ag was formed on this second recording layer by sputtering.

Furthermore, we prepared a polycarbonate substrate having the diameter of 120 mm and the thickness of 0.58 mm, placed it opposite to the reflecting layer, put an ultraviolet curable resin between the reflecting layer and the polycarbonate substrate, made the lower substrate and the upper substrate rotate at high speed to remove an excess amount of the ultraviolet curable resin, and applied ultraviolet light through the upper transparent substrate onto the ultraviolet curable resin to cure this ultraviolet curable resin to form the adhesive layer, thereby completing the optical recording medium.

Each of the optical recording media obtained in this manner was evaluated by recording data at the line speed of 7.68 m/s in the first recording layer and the second recording layer, using an optical disk evaluation system (ODU-1000) of Pulstec Industrial Co., Ltd. equipped with a laser of the wavelength of 650 nm and an optical head of NA=0.65. The recording power was set to a value to obtain an eye pattern where the center of the eye was located at the center of the 14T waveform. After the recording, initial PI (Inner-code-Parity) errors (the number of errors per ECC block) were measured. A light irradiation test was conducted at 60° C. for 40 hours with a light resistance tester of 100000 lux (accumulated illuminance: 4 Mlux·hr) and the PI errors were measured after the light resistance test.

### Comparative Examples a1-aA27

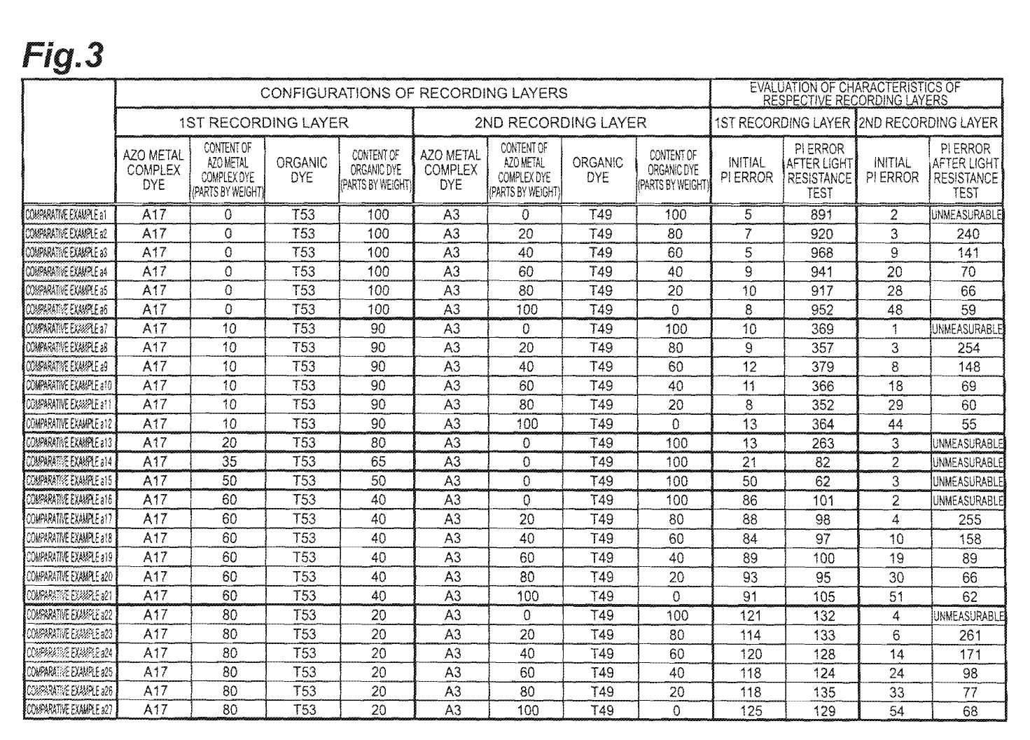

The optical recording media were prepared in the same manner as in Example A1 except that the compounding ratios of the dyes in the first recording layer and the second recording layer were set to be those in each of Comparative Examples a1-a27 in FIG. 3, and each of the recording layers was evaluated.

The results are shown in FIG. 2 and FIG. 3. The initial PI error is desired to be not more than 80. The PI error after the light resistance test is desired to be not more than 280. In the tables, “unmeasurable” means that the value of PI error becomes too large and over the measurement limit of the evaluation system.

In Examples a1-a15 wherein the first recording layer contained 20 to 50 parts by weight of the metal complex dye where the total amount of the metal complex dye and the organic dye was 100 parts by weight and wherein the second recording layer contained 20 to 100 parts by weight of the metal complex dye where the total amount of the metal complex dye and the organic dye was 100 parts by weight, the initial PI error was not more than 80 and the PI error after the light resistance test was not more than 280 in both of the first recording layer and the second recording layer.

Particularly, in Examples a8-a10 and Examples a13-a15 wherein the first recording layer contained 35 to 50 parts by weight of the metal complex dye where the total amount of the metal complex dye and the organic dye was 100 parts by weight and wherein the second recording layer contained 60 to 100 parts by weight of the metal complex dye where the total amount of the metal complex dye and the organic dye was 100 parts by weight, the PI error after the light resistance test was particularly good, 85 or less, in both of the first recording layer and the second recording layer.

On the other hand, in Comparative Examples a1-a27 not satisfying the foregoing condition, the values of the initial PI error and the PI error after the light resistance test were not good in either of the first recording layer and the second recording layer.

### Examples b1-b11

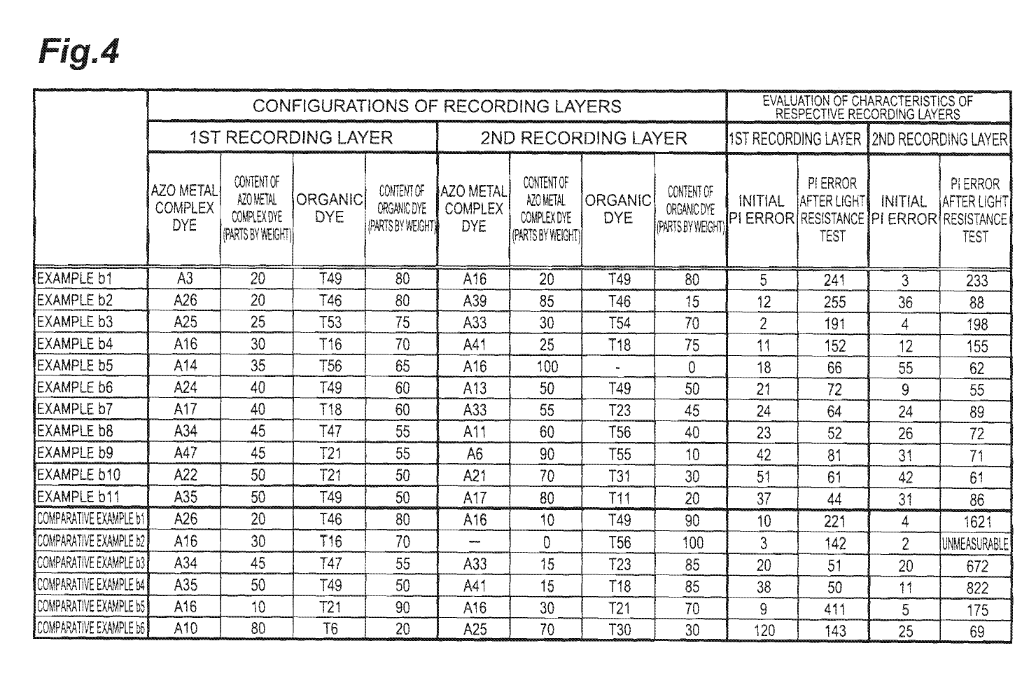

The optical recording media were prepared in the same manner as in Example a1 except that the types and compounding ratio of the azo metal complex dye and the organic dye in the first recording layer and the types and compounding ratio of the azo metal complex dye and the organic dye in the second recording layer were set to be the types and compounding ratios in each of Examples b1-b11 in FIG. 4, and each of the recording layers was evaluated.

### Comparative Examples b1-b6

The optical recording media were prepared in the same manner as in Example b1 except that the types and compounding ratio of the azo metal complex dye and the organic dye in the first recording layer and the types and compounding ratio of the azo metal complex dye and the organic dye in the second recording layer were set to be the types and compounding ratios in each of Comparative Examples b1-b6 in FIG. 4, and each of the recording layers was evaluated.

The materials used herein were a salt with PF₆⁻ for an anion and a salt with tetrabutylammonium for a cation.

In Examples b1-b11 wherein the first recording layer contained 20 to 50 parts by weight of the metal complex dye where the total amount of the metal complex dye and the organic dye was 100 parts by weight and wherein the second recording layer contained 20 to 100 parts by weight of the metal complex dye where the total amount of the metal complex dye and the organic dye was 100 parts by weight, the initial PI error and the PI error after the light resistance test were good in both of the First recording layer and the second recording layer. On the other hand, in Comparative Examples b1-b6 not satisfying this condition, the values of the initial PI error and PI error after the light resistance test were not good in either of the first recording layer and the second recording layer.

1. An optical recording medium comprising a laminate of at least two recording layers,
wherein each of the recording layers contains a metal complex dye and an organic dye in a predetermined concentration,
wherein, when the recording layers comprise a first recording layer and a second recording layer in order from a light entrance side,
the first recording layer contains 20 to 50 parts by weight of the metal complex dye where a total amount of the metal complex dye and the organic dye is 100 parts by weight, and
the second recording layer contains 20 to 100 parts by weight of the metal complex dye where a total amount of the metal complex dye and the organic dye is 100 parts by weight.

2. The optical recording medium according to claim 1, wherein the first recording layer contains 35 to 50 parts by weight of the metal complex dye where the total amount of the metal complex dye and the organic dye is 100 parts by weight.

3. The optical recording medium according to claim 1, wherein the second recording layer contains 60 to 1100 parts by weight of the metal complex dye where the total amount of the metal complex dye and the organic dye is 100 parts by weight.

4. The optical recording medium according to claim 1, wherein the metal complex dye is an azo metal complex dye.

5. The optical recording medium according to claim 4, wherein the azo metal complex dye is a complex compound of an azo compound represented by General Formula (1) below, and a metal; 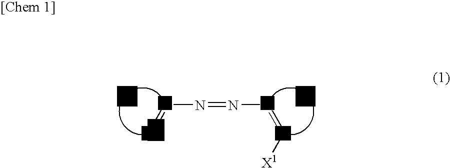
wherein Q¹ indicates a divalent residue binding to each of a nitrogen atom and a carbon atom binding to the nitrogen atom, to form a heterocyclic ring or a fused ring including the heterocyclic ring, Q² a divalent residue binding to each of two carbon atoms binding to each other, to form a fused ring, and X¹ a functional group having at least one active hydrogen atom.

6. The optical recording medium according to claim 1, wherein the organic dye is a cyanine dye.

7. The optical recording material according to claim 6, wherein the cyanine dye has a group represented by General Formula (2) or (3) below; 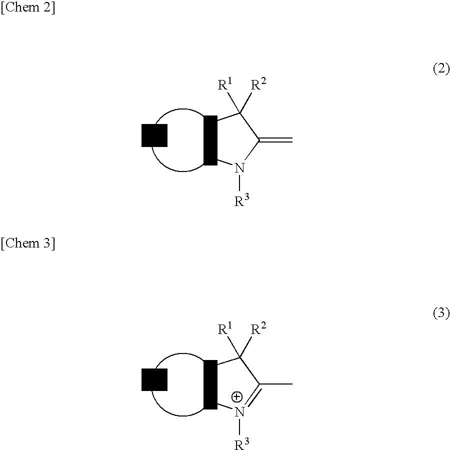
wherein Q³ indicates an atom group constituting a benzene ring that may have a substituent group or a naphthalene ring that may have a substituent group, R¹ and R² each independently indicate an alkyl group, a cycloalkyl group, a phenyl group, or a benzyl group that may have a substituent group, or indicate a group forming a three-, four-, five-, or six-membered ring while they bind to each other, R³ indicates an alkyl group, a cycloalkyl group, an alkoxy group, a phenyl group, or a benzyl group that may have a substituent group and the groups indicated by R¹, R², and R³ may have a substituent group.

8. The optical recording medium according to claim 1, wherein the recording layers comprise only two layers.

9. The optical recording medium according to claim 1, comprising:
a substitute;
the first recording layer provided on the substrate;
a semitransparent reflecting layer provided on the first recording layer;
a spacer layer provided on the semitransparent reflecting layer;
the second recording layer provided on the spacer layer; and
a reflecting layer provided on the second recording layer.

10. The optical recording medium according to claim 2, wherein the second recording layer contains 60 to 100 parts by weight of the metal complex dye where the total amount of the metal complex dye and the organic dye is 100 parts by weight.
